(19) United States
(12) Patent Application Publication
(10) Pub. No.: US 2002/0095655 A1
(43) Pub. Date: Jul. 18, 2002

(54) Apparatus and method for generating enterprise java beans based on class diagram

(76) Inventors: Dong-Kwan Kim, Seoul (KR); Young-Jong Yang, Taejon (KR); Hyo-Taeg Jung, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/925,081

(22) Filed: Aug. 7, 2001

(30) Foreign Application Priority Data
Jan. 12, 2001 (KR) 2001-1943

(51) Int. Cl. G06F 9/44

(52) U.S. Cl. 717/107; 717/109

(57) ABSTRACT

An enterprise java bean generating apparatus and method automatically produces codes based on design information to thereby reduce a development time, a development cost and errors capable of occurring in an enterprise java bean based software development process. The apparatus includes a class diagram receiving unit for receiving the class diagram, an inheritance relationship removing unit for eliminating an inheritance relationship existing among classes in the class diagram, an enterprise java bean extracting unit for extracting the enterprise java beans based on the class diagram whose inheritance relationship was eliminated, an enterprise java bean interface generating unit for producing a remote interface and a home interface of the enterprise java bean, an enterprise java bean grouping unit for grouping enterprise java beans related to each other, and a facade pattern applying unit for applying a facade pattern to the grouped enterprise java beans to thereby unify external interfaces.

### FIELD OF THE INVENTION

The present invention relates to an apparatus and method for generating enterprise java beans based on a class diagram; and, more particularly, to an apparatus and method for generating enterprise java beans by automatically producing codes based on design information to thereby reduce a development time, a development cost and errors capable of occurring in an enterprise java bean based software development process, and a computer readable recording medium in which a program implementing the method is recorded.

### DESCRIPTION OF THE PRIOR ART

As networks develop, distributive software is getting complicated unlike existing independent software. Therefore, software developers start to be concerned about a technology of re-using pre-developed programs so as to satisfy requirements of software users, which are rapidly changing, and complexity of the software-operating environment.

The software development process is roughly classified into an analysis, a design, an implementation, a test and an installation. In the beginning time, the software re-using technology was focused on the re-using of source codes in the implementation process.

The software re-using technology has developed according to a reverse process of the software development, i.e., in order of the implementation, the design, the analysis and the re-using of requirement information.

The researches for the software re-using have been continued for dozens of years through the re-using technology of design patterns, software architectures, frameworks and so on and, recently, a component based re-using technology is beginning to make its appearance in the academic world and in the business world. As a component model presently being on the rise, there is a JAVA based enterprise java bean (EJB) of SUN Microsystems, Inc.

The enterprise java bean provides services through an external interface as a component model of a server end and an inside of the component is formed of a black box. Further, the enterprise bean is provided with services required in distributed applications through middleware referred to as a container.

Enterprise java bean related classes comprise a remote interface for defining a service provided to the outside, a home interface for providing enterprise bean generating and detecting functions, and an enterprise bean having an implementation part for the service provided to the outside, and is roughly classified into an entity bean and a session bean.

The entity bean represents a column of a database table, i.e., a record, and supports a developer to perform a database related work more comfortably by abstracting a database.

The session bean has an operation carrying out business logic and approaches the database through the entity bean.

As shown above, since the entity bean represents the record, it needs a primary key. In general, the primary key is implemented as a separate class.

It is possible to easily develop a web-based distributive system by using transaction, persistence and expandability provided by the enterprise java bean component model and, in future, the characteristics can be re-used in developing a system having same problems.

However, although the component technology using the enterprise java bean gets into the spotlight, in a position of software developers, there are files that must be prepared to use the technology. For instance, the developers should make out a home interface, a remote interface and bean classes.

In preparing the above classes, errors can occur and it makes a problem contrary to a goal using the component technology.

In particular, since developers who were using a conventional object-oriented method manually perform a sequence of processes for extracting the classes from a class diagram, there was a problem debasing the efficiency.

### SUMMARY OF THE INVENTION

It is, therefore, an object of the present invention to provide an apparatus and method for generating enterprise java beans based on a class diagram to thereby reduce a development time, a development cost and errors capable of occurring in an enterprise java bean based software development process, and a computer readable recording medium in which a program implementing the method is recorded.

In accordance with an aspect of the present invention, there is provided an apparatus for generating enterprise java beans based on a class diagram, which comprises:

a class diagram receiving means for receiving the class diagram;

an inheritance relationship removing means for eliminating an inheritance relationship existing among classes in the class diagram;

an enterprise java bean extracting means for extracting the enterprise java beans based on the class diagram whose inheritance relationship was eliminated;

an enterprise java bean interface generating means for producing a remote interface and a home interface of the enterprise java beans extracted by the enterprise java bean extracting means;

an enterprise java bean grouping means for grouping enterprise java beans related to each other whose interfaces are produced by the enterprise java bean interface generating means; and

a facade pattern applying means for applying a facade pattern to the enterprise java beans grouped by the enterprise java bean grouping means to thereby unify external interfaces.

In accordance with another aspect of the present invention, there is provided a method applied to an apparatus for generating enterprise java beans based on a class diagram, which comprises the steps of:

(a) eliminating an inheritance relationship existing among classes in the class diagram;

(b) extracting the enterprise java beans based on classes whose inheritance relationship is eliminated;

(c) adding an enterprise java bean interface to the extracted enterprise java beans;

(d) grouping interface added enterprise java beans which are related to each other; and

(e) applying a facade pattern to the grouped enterprise java beans.

In accordance with still another aspect of the present invention, there is provided a computer program product for use in an enterprise java bean generating apparatus including a mass storage processor, comprising:

a computer readable medium;

first program instruction means for eliminating an inheritance relationship existing among classes in the class diagram;

second program instruction means for extracting enterprise java beans based on classes whose inheritance relationship is eliminated;

third program instruction means for adding an enterprise java bean interface to the extracted enterprise java beans;

fourth program instruction means for grouping interface added enterprise java beans which are related to each other; and

fifth program instruction means for applying a facade pattern to the grouped enterprise java beans.

### BRIEF DESCRIPTION OF THE DRAWINGS

The objects and features of the present invention will become apparent from the following description of preferred embodiments given in conjunction with the accompanying drawings, in which:

FIG. 1 exemplarily shows a conventional enterprise java bean based software development process;

FIG. 2 depicts a software development process using an enterprise java bean generating apparatus in accordance with a preferred embodiment of the present invention;

FIG. 3 represents a block diagram of the enterprise java bean generating apparatus in accordance with a preferred embodiment of the present invention;

FIG. 4 is a flowchart of showing an enterprise java bean generating method in accordance with a preferred embodiment of the present invention;

FIG. 5 illustrates a flowchart of presenting a class grouping process in accordance with a preferred embodiment of the present invention;

FIGS. 6A to 6C explain a class relationship in accordance with a preferred embodiment of the present invention;

FIG. 7 describes the class grouping process in accordance with a preferred embodiment of the present invention;

FIG. 8 presents a hospital class diagram performing the class grouping in accordance with a preferred embodiment of the present invention;

FIG. 9 shows a flowchart of providing an enterprise java bean extracting process in accordance with a preferred embodiment of the present invention;

FIG. 10 depicts a flowchart of showing an interface adding process for an enterprise java bean in accordance with a preferred embodiment of the present invention;

FIG. 11 explains the interface adding process in accordance with a preferred embodiment of the present invention; and

FIG. 12 illustrates a facade pattern applying process in accordance with a preferred embodiment of the present invention.

### DETAILED DESCRIPTION OF THE PREFERRED EMBODIMENTS

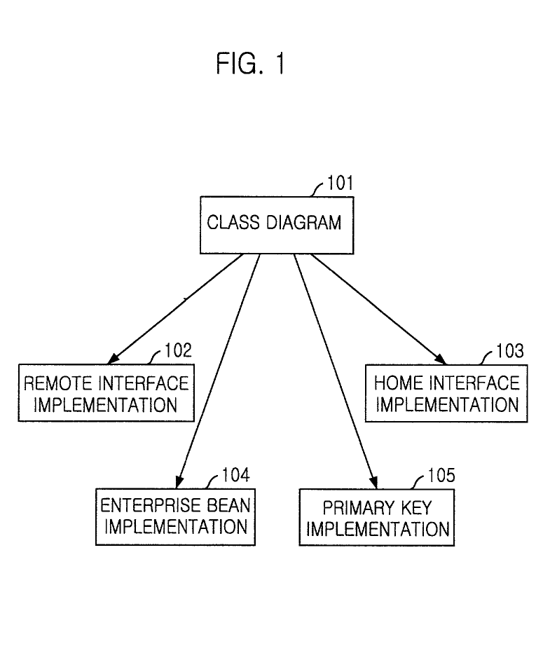

Referring to FIG. 1, there is shown a conventional enterprise java bean based software development process, which represents a process implementing an enterprise java bean from a class diagram.

A software developer produces a class diagram 101 through an analysis and design for a problem region.

As described in FIG. 1, the class diagram 101 generated through the analysis and design for the problem region is provided to a client end according to an enterprise component model. Then, there are implemented a remote interface 102 having operations related to a business logic, a home interface 103 defining operations related to a generation and a finder for the enterprise java bean, an enterprise bean 104 having a practical implementation part for the business logic, and a primary key 105 when a bean constituting the enterprise bean 104 is an entity bean.

The software developer manually performs a process moving from the class diagram 101 to the component implementation.

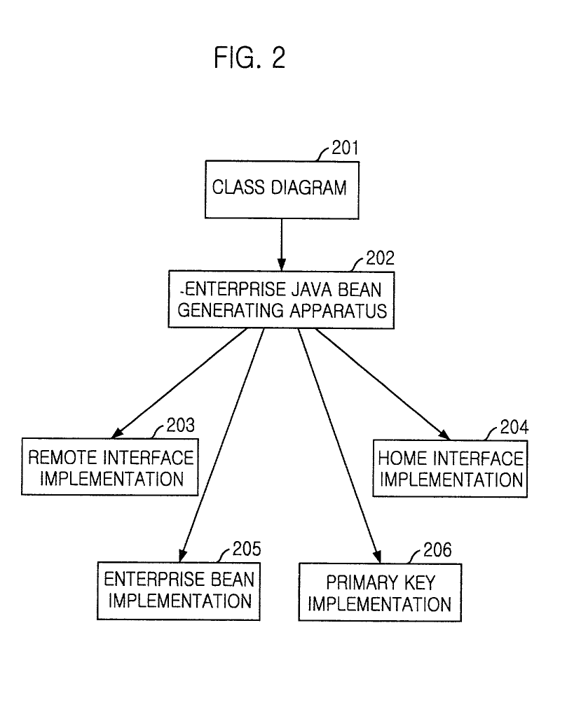

Referring to FIG. 2, there is depicted a software development process using an enterprise java bean generating apparatus in accordance with a preferred embodiment of the present invention, which briefly shows an enterprise java bean generating process by using the enterprise java bean generating apparatus.

The software development process described in FIG. 2 includes the enterprise java bean generating apparatus 202 in addition to the conventional process shown in FIG. 1.

Unlike manually performed in the conventional process, the implementation of a remote interface 203, a home interface 204, an enterprise bean 205 and a primary key 206 is automatically performed by the enterprise java bean generating apparatus 202.

That is, the enterprise java bean generating apparatus 202 implements the enterprise java bean by using information such as class names, class properties, class operations, relationships between classes expressed in a class diagram 201. In a mapping process between the class diagram 201 and the enterprise java bean, it is determined which class is decided as an entity bean or a session bean.

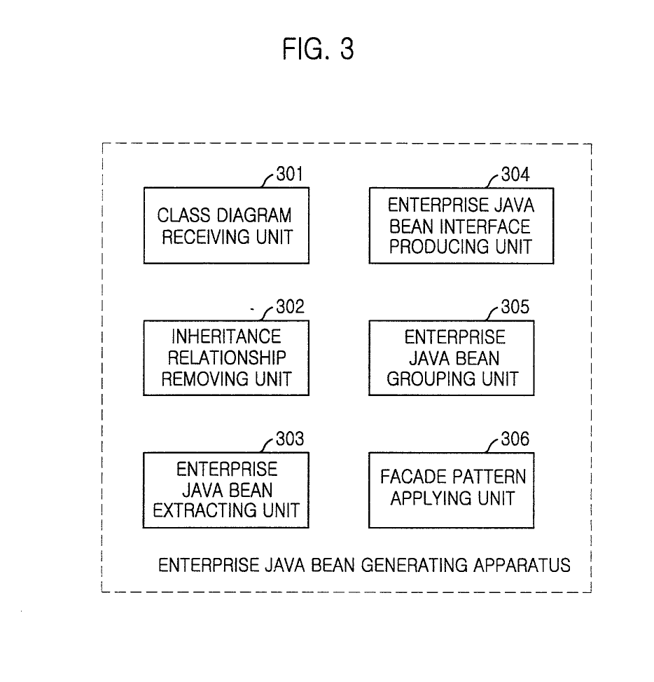

FIG. 3 represents a block diagram of the enterprise java bean generating apparatus in accordance with a preferred embodiment of the present invention.

As illustrated in FIG. 3, the enterprise java bean generating apparatus comprises a class diagram receiving unit 301 for receiving a class diagram produced by an analysis and design for a problem region, an inheritance relationship removing unit 302 for eliminating an inheritance relationship existing among classes of the class diagram inputted to the class diagram receiving unit 301, an enterprise java bean extracting unit 303 for extracting an entity bean and a session bean from the class diagram not having the inheritance relationship, an enterprise java bean interface producing unit 304 for generating a remote interface and a home interface of the enterprise java bean extracted at the enterprise java bean extracting unit 303, an enterprise java bean grouping unit 305 for packaging beans mutually related to each other among enterprise java beans whose interfaces are generated at the enterprise java bean interface producing unit 304, and a facade pattern applying unit 306 for applying a facade pattern to the grouped enterprise java beans so as to provide a unified interface to the grouped enterprise java beans.

That is, the enterprise java bean generating apparatus receives the class diagram and then produces enterprise java bean related classes.

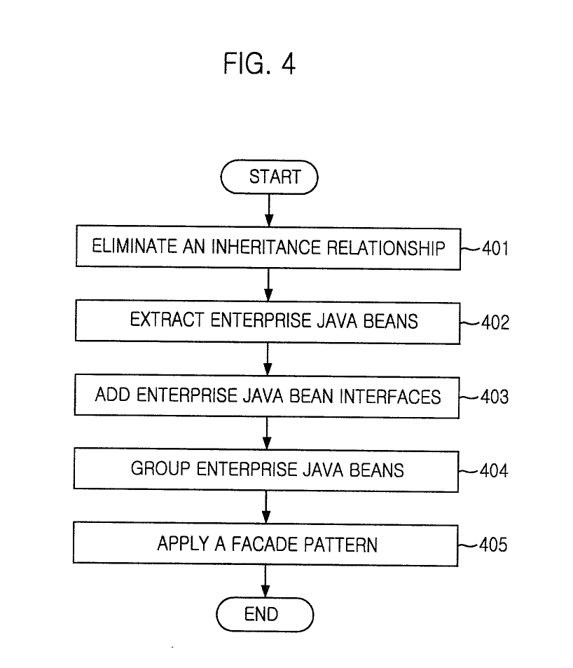

Referring to FIG. 4, there is illustrated a flowchart of showing an enterprise java bean generating method in accordance with a preferred embodiment of the present invention.

According to the enterprise java bean generating method shown in FIG. 4, an inheritance relationship is eliminated in step 401. In step 402, an enterprise java bean is extracted. An enterprise java bean interface is added in step 403 and enterprise java beans are grouped in step 404. Then, in step 405, a facade pattern is applied to the grouped enterprise java beans.

The inheritance relationship removing process 401 converts the inheritance relationship existing among the classes in the class diagram to a delegation technique by using an aggregation relationship. This is for obtaining an inheritance relationship effect by implementing the above relationship as the delegation relationship since the inheritance relationship is not effectively supported in the enterprise java bean component model.

In the enterprise java bean extracting process 402, an entity bean or a session bean is extracted from the classes whose inheritance relationship was removed. In general, each of the classes is mapped to the entity bean or the session bean. A class, which is stored in a database and should maintain its persistence, is mapped to the entity bean, while a class whose persistence needs not to be guaranteed is mapped to the session bean. According to circumstances, one class can be separated into the entity bean and the session bean. That is, a property part of the class is mapped to the entity bean and its operation part is mapped to the session bean.

Meanwhile, in the enterprise java bean interface adding process 403, a remote interface, a home interface and a primary key are generated for each bean extracted in the enterprise java bean extracting process 402. Herein, the remote interface has an operation related to the business logic what the enterprise bean has and the home interface has methods related to the enterprise bean generation (create method) and detection (finder method). The primary key is required only to the entity bean and performs a primary key function of a database table.

In the enterprise java bean grouping process 404, the enterprise java beans extracted in the enterprise java bean interface adding process 403 are inputted and, among them, beans related to each other are packaged. This is for providing one interface by grouping mutually related beans so as to use the interface as a basic unit of the re-using.

In the facade pattern applying process 405, the grouped enterprise java beans are tied through one interface and thus there is an advantage of easily approaching the grouped beans through one path in a viewpoint of external devices. Herein, a session bean representing the grouped beans is added. The session bean has operations provided by the grouped enterprise java beans and performs a function that delivers messages inputted from the outside to a specific bean. Further, bean users cannot see the inside of the beans and use the grouped enterprise java beans through the use of the session bean acting as a facade.

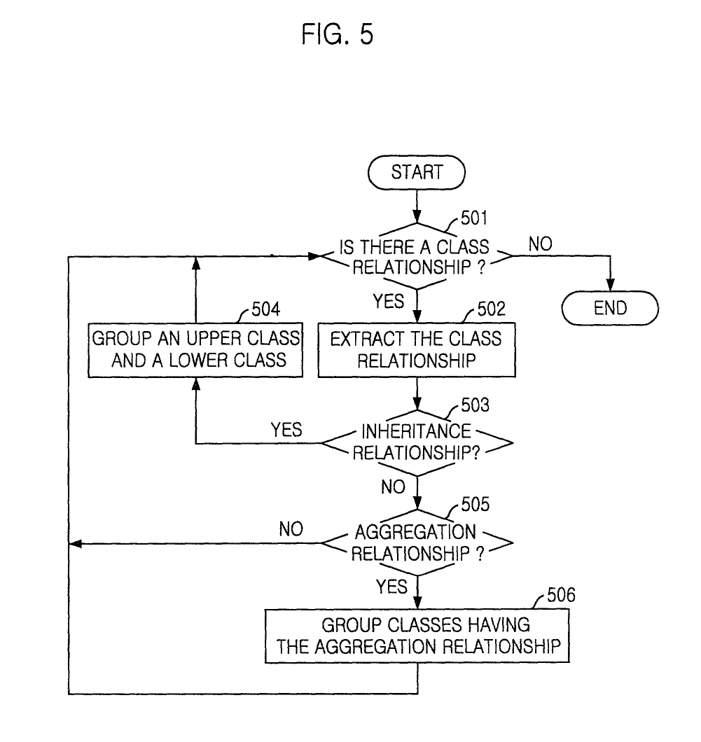

Referring to FIG. 5, there is illustrated a flowchart of presenting a class grouping process in accordance with a preferred embodiment of the present invention.

In accordance with the present invention, classes mutually related to each other are grouped, used on a component basis, and hereafter becomes a unit of component arrangement and execution.

As described in FIG. 5, the class grouping process judges whether there is a class relationship in the class diagram in step 501.

As a judging result, if there is no class relationship, this grouping process terminates. If otherwise, the class relationship is extracted in step 502 and then it is decided if the class relationship is an inheritance relationship in step 503. If the class relationship is determined as the inheritance relationship, an upper class and a lower class having the inheritance relationship are grouped in step 504 and this process goes to step 501 to determine whether there is another class relationship. On the other hand, if there is no inheritance relationship, in step 505, it is decided if the class relationship is an aggregation relationship.

As a result of step 505, if so, a whole class and a part class are grouped in step 506 and then step 501 is performed. If otherwise, the process directly goes to step 501 without the grouping in step 506.

In this grouping process, as excluding a relationship that is neither the inheritance relationship nor the aggregation relationship, the judging process deciding whether there is a new class relationship in the class diagram is repeatedly executed until there is no class relationship.

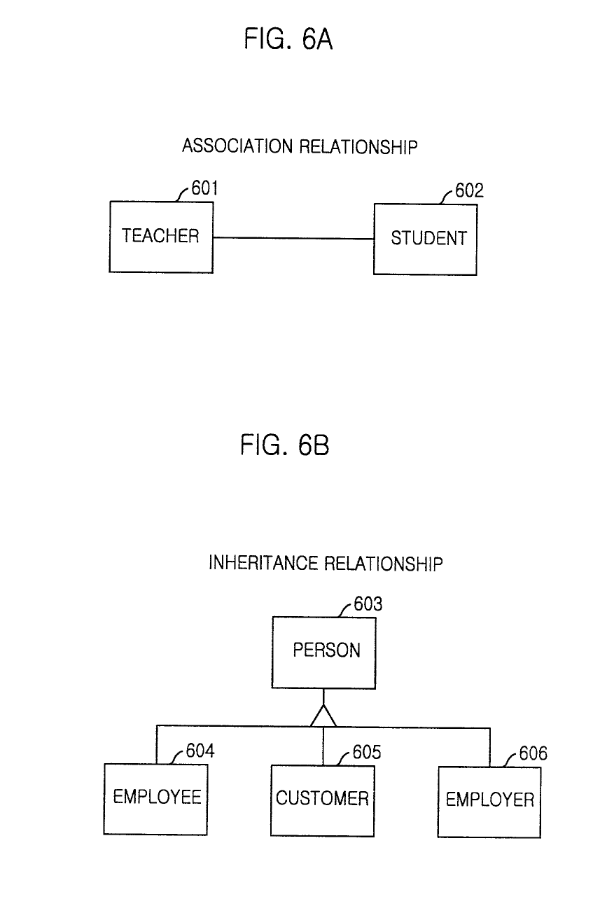

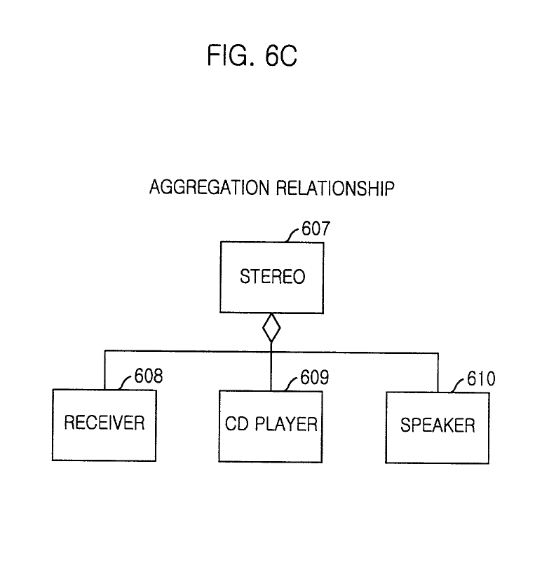

FIGS. 6A to 6C explain a class relationship in accordance with a preferred embodiment of the present invention.

Through the class grouping process, classes are grouped by considering a relationship between the classes. The relationship will be described hereinafter.

First of all, the class relationship is classified into an association relationship representing a relationship between two classes, an inheritance relationship meaning that a lower class uses an instance variable and method of an upper class as if it directly defines the instance variable and method therein, and an aggregation relationship presenting that one class includes objects generated in another class and an instance variable of the included class is used like that of the including class.

Referring to FIG. 6A, there is exemplarily shown the association relationship, which is a relationship in which two classes are equivalent like a teacher class 601 and a student class 602.

FIG. 6B represents the inheritance relationship, which consists of an upper class and lower classes. A person class 603 is the upper class, and an employee class 604, a customer class 605 and an employer class 606 are the lower classes.

Referring to FIG. 6C, there is presented the aggregation relationship, which is made of a whole class and part classes. A stereo class 607 is the whole class, and a receiver class 608, a CD player class 609 and a speaker class 610 are the part classes.

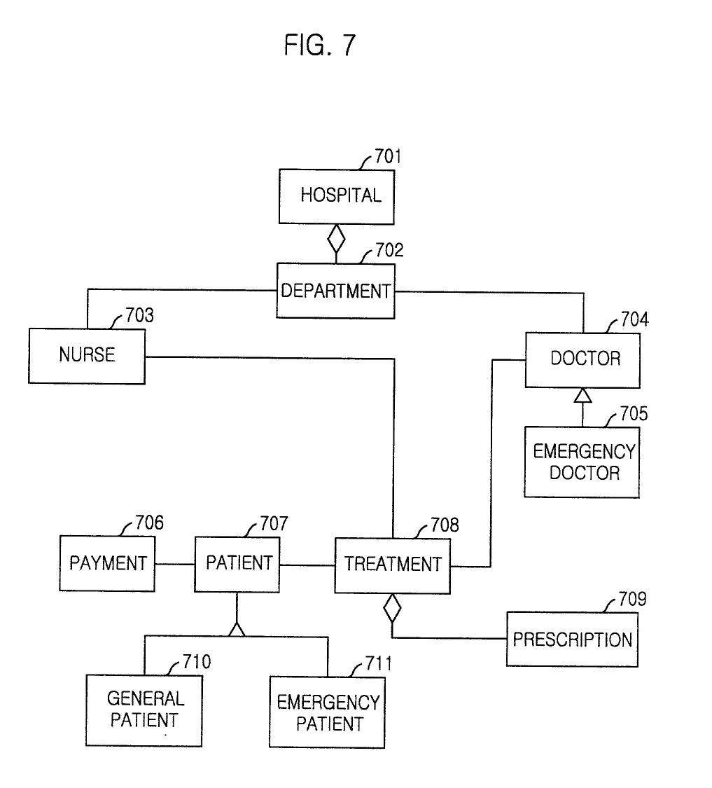

In FIG. 7, there is described the class grouping process in accordance with a preferred embodiment of the present invention.

As illustrated in FIG. 7, a simplified class diagram for a hospital domain will be disclosed hereinafter.

As first, a hospital class 701 establishes the aggregation relationship with a department class 702 and there exist a nurse class 703 and a doctor class 704. The doctor class 704 includes an emergency doctor class 705 inheriting the doctor class 704.

A patient class 707 is separated into a general patient class 710 and an emergency patient class 711 and the patient class 707 is related with the doctor class 704 through a treatment class 708.

The treatment class 708 has a prescription class 709 as its part class and the patient class 707 is associated with a payment class 706. That is to say, the classes included in the class diagram have the association, inheritance and aggregation relationships.

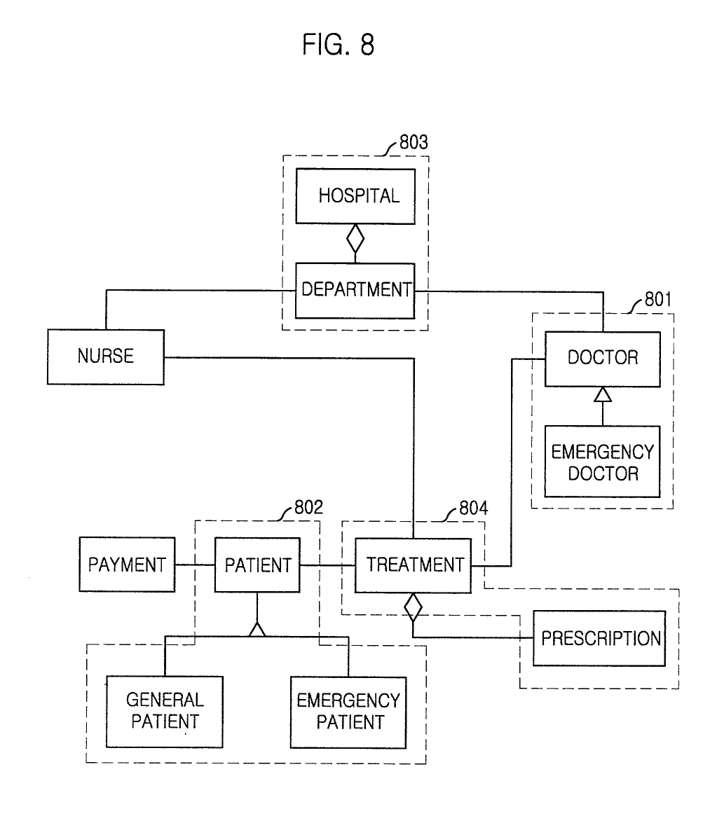

Referring to FIG. 8, there is presented a hospital class diagram performing the class grouping process in accordance with a preferred embodiment of the present invention, which shows a result of applying the class grouping described in FIG. 6 to the hospital class diagram of FIG. 7.

If extracting the inheritance relationship from the class diagram, the doctor class and the emergency doctor class 801, and the patient class, the general patient class and the emergency patient class 802 are in the inheritance relationship. Thereafter, the classes are first grouped.

Once the classes establishing the inheritance relationship are grouped, then, classes having the aggregation relationship are extracted. That is, the hospital class and the department class 803, and the treatment class and the prescription class 804 are in the aggregation relationship, and, thereafter, the classes are grouped.

Since the remaining classes are in the association relationship, the remaining classes are excluded from the class grouping.

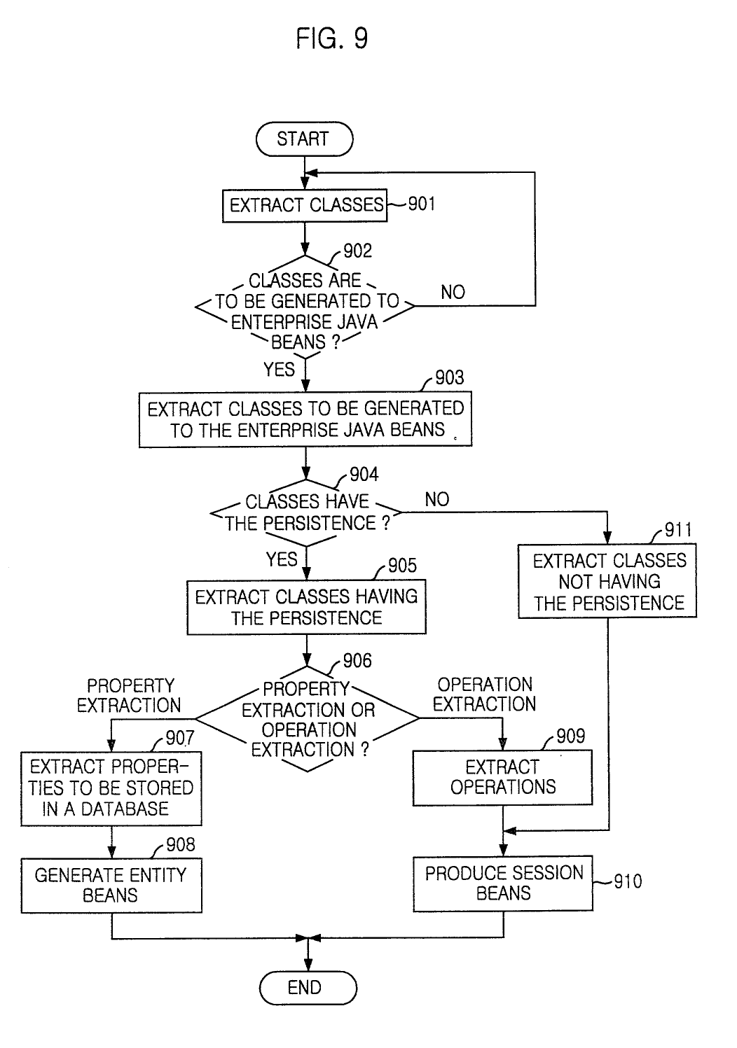

Referring to FIG. 9, there is shown a flowchart of providing an enterprise java bean extracting process in accordance with a preferred embodiment of the present invention.

In step 901, classes are extracted from the class diagram and then it is determined whether the classes are generated to enterprise java beans or not in step 902.

As a result of the determination process, if the classes are not generated to the enterprise java beans, this process returns to step 901. If otherwise, classes to be generated to the enterprise java beans are extracted in step 903. Then, in step 904, it is decided whether the persistence is guaranteed for the extracted classes or not.

As a result of the decision process in step 904, if the extracted classes have the persistence, classes having the persistence are extracted in step 905 and then it is determined if the extraction is either property extraction to be stored in a database or operation extraction in step 906.

If it is determined that the extraction is the property extraction to be stored in the database, this process extracts properties of the extracted classes having the persistence in step 907 and generates the properties to entity beans in step 908.

If it is decided that the extraction is the operation extraction, this process extracts operation parts of the extracted classes having the persistence in step 909 and produces the operation parts to session beans in step 910.

If it is determined that the extracted classes do not have the persistence in step 904, this process extracts classes whose persistence may not be guaranteed in step 911 and generates the extracted classes not having the persistence to session beans in step 910.

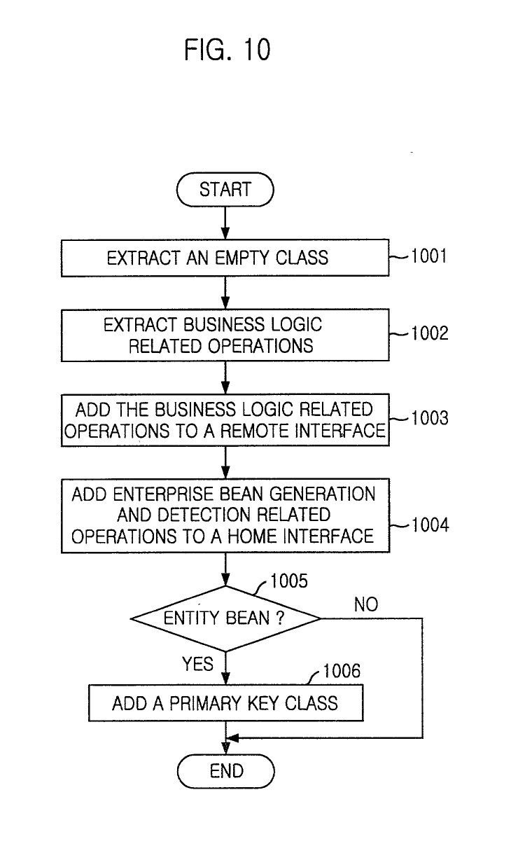

Referring to FIG. 10, there is depicted a flowchart of showing an interface adding process for an enterprise java bean in accordance with a preferred embodiment of the present invention, which represents a process of adding required interfaces to the enterprise java beans extracted through the processes described in FIG. 9.

At first, an empty class is extracted in step 1001 and business logic operations related to a problem region are taken out in step 1002. The operations are added to a remote interface in step 1003.

Then, operations related to the enterprise bean generation and detection are added to a home interface in step 1004. In step 1005, it is determined whether a specific bean is an entity bean or not. If the specific bean is decided as the entity bean, a primary key class is added to the specific bean in step 1006 and, if otherwise, this process is completed.

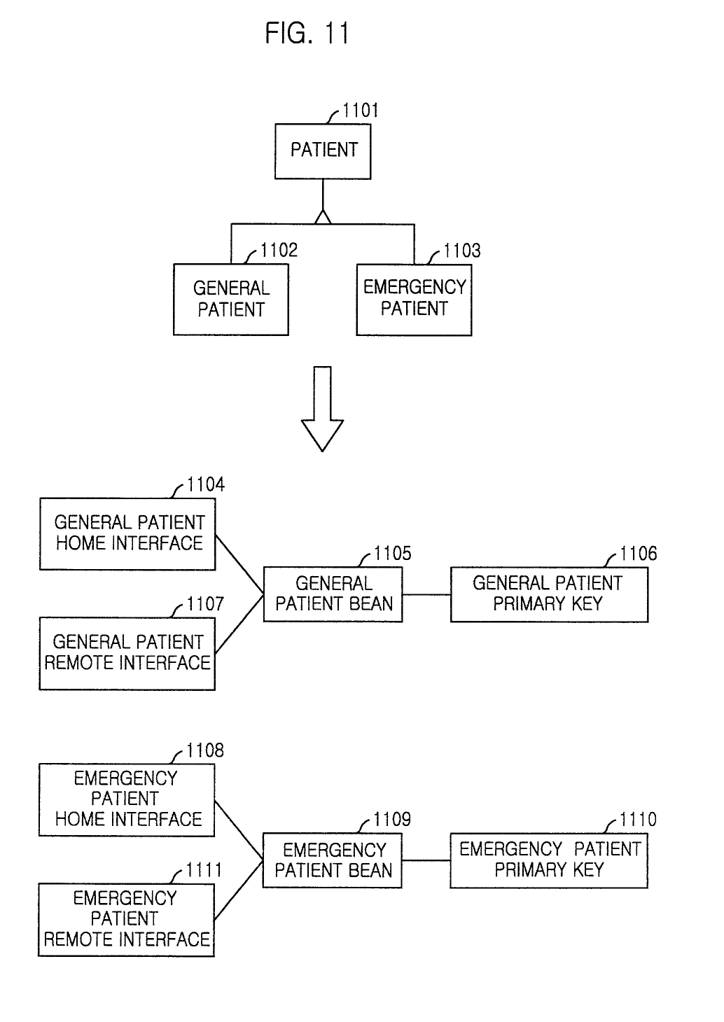

FIG. 11 explains the interface adding process in accordance with a preferred embodiment of the present invention.

A patient class is selected from the hospital class diagram shown in FIG. 7. When transforming a patient class 1101 to an enterprise java bean and removing its inheritance relationship, a general patient class 1102 and an emergency patient class 1103 are extracted.

In order to convert the general patient class 1102 to a bean, a general patient remote interface (GPRemoteInterface) class 1107 and a general patient home interface (GPHomeInterface) class 1104 are added. Since the general patient class 1102 is an entity bean, a primary key (GPPrimaryKey) class 1106 is added thereto.

Since the emergency patient class 1103 is also an entity bean like the general patient class 1102, an emergency patient remote interface (EPRemoteInterface) class 1111, an emergency patient home interface (EPHomeInterface) class 1108 and an emergency patient primary key (EPPrimaryKey) class 1110 are added thereto.

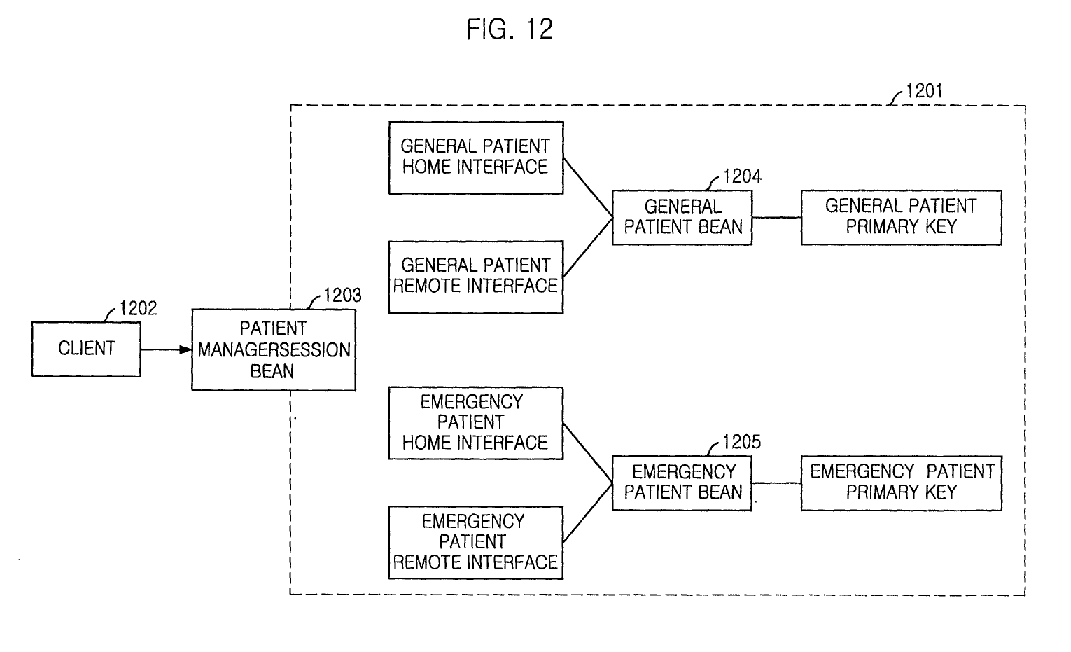

Referring to FIG. 12, there is illustrated a facade pattern applying process in accordance with a preferred embodiment of the present invention.

The facade pattern applying process connects together the enterprise beans grouped in the enterprise java bean grouping process by using one interface.

For the purpose, the facade pattern is applied to a general patient bean (GPBean) class 1105 and an emergency patient bean (EPBean) class 1109 shown in FIG. 11.

In FIG. 12, a client class 1202 cannot directly approach a general patient bean (GPBean) 1204 and an emergency patient bean (EPBean) 1205 and can approach them through a patient management session bean class 1203 that is a single interface. That is, the patient management session bean 1203 performs the facade function.

The present invention described above can be implemented as a program and then stored in a recording medium such as a CDROM, RAM, ROM, floppy disk, hard disk, magneto-optical disk, or the like.

As illustrated above, compared with the prior art manually generating the enterprise java beans based on design information or automatically performing a part of tasks, by using the enterprise java bean generating apparatus in accordance with the present invention, it is possible to reduce errors occurring in the enterprise java bean development, a software development time and a development cost.

While the present invention has been described with respect to the particular embodiments, it will be apparent to those skilled in the art that various changes and modifications may be made without departing from the spirit and scope of the invention as defined in the following claims.

What is claimed is:

1. An apparatus for generating enterprise java beans based on a class diagram, comprising:
a class diagram receiving means for receiving the class diagram;
an inheritance relationship removing means for eliminating an inheritance relationship existing among classes in the class diagram;
an enterprise java bean extracting means for extracting the enterprise java beans based on the class diagram whose inheritance relationship was eliminated;
an enterprise java bean interface generating means for producing a remote interface and a home interface of the enterprise java beans extracted by the enterprise java bean extracting means;
an enterprise java bean grouping means for grouping enterprise java beans related to each other whose interfaces are produced by the enterprise java bean interface generating means; and
a facade pattern applying means for applying a facade pattern to the enterprise java beans grouped by the enterprise java bean grouping means to thereby unify external interfaces.

2. The apparatus of claim 1, wherein the enterprise java bean extracting means maps a class, which is stored in a database and should maintain its persistence, to an entity bean, and a class whose persistence needs not to be guaranteed to a session bean.

3. The apparatus of claim 1, wherein the enterprise java bean interface generating means produces a primary key if a class is mapped to an entity bean.

4. A method for generating enterprise java beans based on a class diagram, comprising the steps of:
(a) eliminating an inheritance relationship existing among classes in the class diagram;
(b) extracting the enterprise java beans based on classes whose inheritance relationship is eliminated;
(c) adding an enterprise java bean interface to the extracted enterprise java beans;
(d) grouping interface added enterprise java beans which are related to each other; and
(e) applying a facade pattern to the grouped enterprise java beans.

5. The method as recited in claim 4, wherein the step (b) includes the steps of:
(b1) extracting classes from the class diagram and determining whether or not generating the extracted classes to the enterprise java beans;
(b2) if it is determined that the extracted classes are not generated to the enterprise java beans, returning to the step (b1) and, if otherwise, extracting classes to be generated to the enterprise java beans;
(b3) deciding if the persistence of the extracted classes is guaranteed;
(b4) if the extracted classes have the persistence, detecting classes having the persistence and generating the detected classes to the enterprise java beans; and
(b5) if the extracted classes do not have the persistence, determining classes not having the persistence and producing the determined classes to session beans.

6. The method as recited in claim 5, wherein the step (b4) includes the steps of:
(b41) extracting the classes having the persistence;
(b42) deciding whether said extraction is either property extraction to be stored in a database or operation extraction;
(b43) if said extraction is determined as the property extraction, generating an entity bean by extracting a property to be stored in the database; and
(b44) if said extraction is decided as the operation extraction, producing a session bean by extracting an operation.

7. The method as recited in claim 4, wherein the step (c) includes the steps of:
(c1) taking out business logic operations related to a problem region from an extracted empty class;
(c2) adding the extracted business logic operations to a remote interface;
(c3) adding operations related to the enterprise java bean generation and detection to a home interface; and
(c4) identifying the extracted enterprise java bean as an entity bean and adding a primary key class.

8. The method as recited in claim 7, wherein the step (d) includes the steps of:
(d1) determining whether there is a class relationship;
(d2) if it is determined that there is the class relationship, extracting the class relationship and deciding if the class relationship is an inheritance relationship;
(d3) if it is decided that the class relationship is the inheritance relationship, grouping an upper class and a lower class which establish the inheritance relationship with each other and proceeding to the step (d1), and, if otherwise, checking out whether the class relationship is an aggregation relationship or not;
(d4) if the class relationship is determined as the aggregation relationship, grouping a whole class and a part class which establish the aggregation relationship with each other and then returning to the step (d1), and, if otherwise, going to the step (d1).

9. A computer program product for use in an enterprise java bean generating apparatus including a mass storage processor, comprising:
a computer readable medium;
first program instruction means for eliminating an inheritance relationship existing among classes in the class diagram;
second program instruction means for extracting enterprise java beans based on classes whose inheritance relationship is eliminated;
third program instruction means for adding an enterprise java bean interface to the extracted enterprise java beans;
fourth program instruction means for grouping interface added enterprise java beans which are related to each other; and
fifth program instruction means for applying a facade pattern to the grouped enterprise java beans.
